(19) United States
(12) Patent Application Publication
(10) Pub. No.: US 2006/0291031 A1
(43) Pub. Date: Dec. 28, 2006

(54) Arrangement of aperture diaphragms and/or filters, with changeable characteristics for optical devices

(76) Inventors: Klaus Boehm, Schleifreisen (DE); Peter Schaeffer, Oberkochen (DE); Wolfgang Harnisch, Lehesten (DE); Thomas Engel, Erfurt (DE); Axel Zibold, Jena (DE); Bernd Geh, Schottsdale, AZ (US)

Correspondence Address: JACOBSON HOLMAN PLLC, 400 SEVENTH STREET N.W., SUITE 600, WASHINGTON, DC, 20004, US

(21) Appl. No.: 11/429,428

(22) Filed: May 8, 2006

Related U.S. Application Data
(63) Continuation-in-part of application No. PCT/EP04/12369, filed on Nov. 2, 2004.

(30) Foreign Application Priority Data
Nov. 7, 2003 (DE) 103 52 040.6

(51) Int. Cl. G02F 1/01

(52) U.S. Cl. 359/279

(57) ABSTRACT

An arrangement making use of two-dimensional arrays consisting of individually controllable elements, for forming aperture diaphragms in the beam paths of optical devices. In an arrangement of diaphragm apertures and/or filters, in which the form, position and/or optical characteristics can be changed, for use in optical devices, at least one two-dimensional array, consisting of individually controllable elements, is arranged for forming the diaphragm apertures and/or filters in the optical imaging and/or illumination beam paths and is connected with a control unit for controlling the individual elements In this way, the geometry, the optical characteristics and/or the position of the aperture diaphragms and/or the filters can be controlled very quickly. These changes can also be made “online” during the process of measurement or adjustment in the sense of optical fine tuning. Furthermore, using these systems, the elaborate and time consuming preparation of the diaphragm apertures with geometric forms can be omitted.

### BACKGROUND OF THE INVENTION

(1) Field of the Invention

The present invention relates to the use of two-dimensional arrays, with individually controllable elements, for forming diaphragm apertures in the beam paths of optical devices, in particular of microscopes, for the inspection of masks and wafers. By electronically controlling the individual elements, the form, position and/or the optical characteristics of the aperture diaphragms and/or the filters thus formed can be changed.

(2) Description of Related Art

In the prior art, diaphragms used in microscopes are in general prepared mechanically and positioned in a beam path. To change the form of a diaphragm aperture, the diaphragm must be replaced. This is done, for example, by rotating a diaphragm wheel, on which different diaphragms are arranged. To properly position the diaphragms, three-dimensional alternatives for the adjustment and the corresponding manipulators are required. Accordingly, an elaborate process is involved in the adjustment of this type of diaphragm and in particular of the diaphragm wheels found in the microscope.

Proposals for solving this problem are known in the prior art. In particular, the prior art uses devices with electronically controllable light modulators for generation of the patterns.

For example, in U.S. Pat. No. 5,113,332, a diaphragm wheel and a filter wheel are described, in which, among other things, diaphragms made of transparent LCD elements are arranged so that they can be optionally inserted in the projection beam path. By using the LCD elements, the number of possible aperture diaphragms and filters can be increased considerably by using different types of electrical manipulation. The LCD elements are in a position to provide an unlimited number of patterns in a rapid sequence, so that it is possible to generate special dynamic illumination effects. Since a replacement of the filters and the diaphragms arranged in the wheel is thus hardly necessary, the technical effort involved in the justification of the diaphragm and the filter wheels can be reduced to a one-time installation. However, the support and the guiding of the wheel as well as to the wheel itself, demand very high accuracy like before.

Use of the so-called Spatial Light Modulators (SLM) in pattern generators is proposed in U.S. Pat. No. 6,285,488 assigned to Micronic Laser Systems. In the patent, an array of individually controllable micro-mirrors is used as an SLM. Starting from a pulse light source with an arbitrary wavelength, an image or a pattern is generated on a workpiece to be illuminated by means of the individual micro-mirrors. The photomasks, wafers, pressure plates, and so on, preferably called workpieces here, are positioned by a stepper system in such a manner that the patterns generated by the SLMs are aligned in a mutually precise matching manner on the workpiece. An electronic control system coordinates the pulse light source, the controls of the SLMs as well as of the stepper system. For precise matching of the individual patterns on the workpiece, the workpieces must have the same corresponding pattern at the borders. As a result, the demands placed on the control system, and in particular on the stepper system, are especially high. In the proposed solution, the intensity of light in the border areas of the individual patterns is reduced. A complete pattern with uniform light intensity is achieved by overlapping these border areas. The technical complexity and expense involved in achieving such a precisely matching uniform pattern is very high.

### BRIEF SUMMARY OF THE INVENTION

The underlying task of the present invention is to develop a solution, with which it is possible to change the size or the geometry of the diaphragm apertures and/or their optical characteristics in microscopy systems with as little time and effort to accomplish the adjustment as possible. In this way, it should be possible to use the solution independent of the wavelength of the light for the widest variety of microscopy systems.

In the proposed solution, the optical diaphragms and/or filters are replaced by suitable arrangements of arrays with locally controllable elements. The form, position and/or the optical characteristics of the arrangement of the diaphragm apertures and/or the filters can be changed very quickly using electronic control. Furthermore, by means of the electronic control, the diaphragm apertures can, on one hand, be centered and, on the other hand, be decentered in a targeted manner, in order to compensate for existing aberrations through the adjustments of the apertures. These changes can also be made “online” during the process of measurement and adjustment in the sense of optical fine tuning. In addition to that, by using these systems, the elaborate and time consuming preparations for the diaphragm apertures with geometric forms and the filters with various optical characteristics can be omitted.

The proposed technical solution can be used in principle not only in all microscopes, but also in optical imaging systems like binoculars, projectors, cameras and so on.

### BRIEF DESCRIPTION OF THE DRAWING

The invention is described in the following on the basis of an exemplary embodiments shown in the drawings where:

FIG. 1 is a schematic diagram of an inventive solution for use in a microscope system, preferably for inspection of masks or wafers;

FIG. 2 is a block diagram showing the position of a two-dimensional array in the context of the present invention;

FIG. 3 is a listing of possible embodiments of the two-dimensional array of the present invention;

FIG. 4 is a schematic diagram of another embodiment of the invention using a self-illuminating array;

FIG. 5 is a schematic diagram of an embodiment of the invention employing zoom optics; and

FIG. 6 is a schematic diagram of an embodiment of the invention illustrating placement of a two-dimensional array in an image beam path.

### DETAILED DESCRIPTION OF THE INVENTION

In the description that follows, like parts are marked throughout the specification and drawings with the same reference numerals, respectively.

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

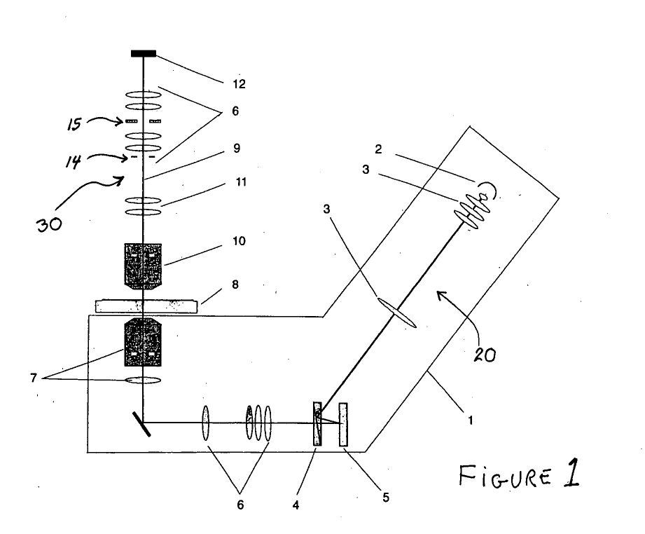

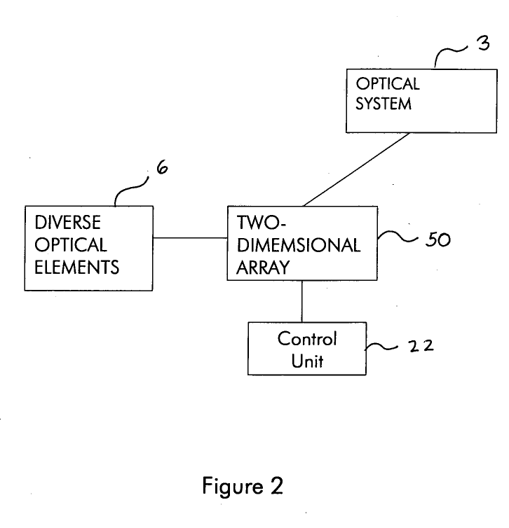

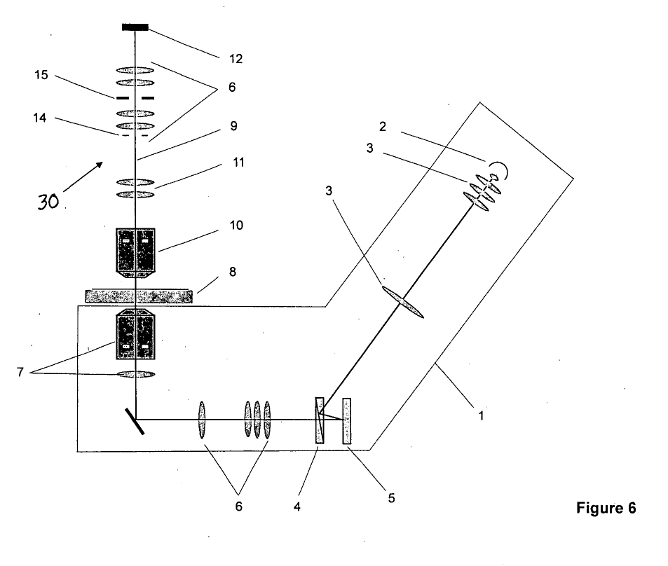

With reference to FIGS. 1-3, in an arrangement of diaphragm apertures and/or filters, in which the form, position and/or optical characteristics can be changed, for use in optical devices, in particular in microscopes, at least one two-dimensional array 50, consisting of individually controllable elements, is arranged for forming the diaphragm apertures and/or filters in the optical imaging 20 and/or illumination beam path 30 and is connected with a control unit 22 for controlling the individual elements. See, for example, FIG. 6 which shows an array in the imaging beam path 30 that is placed in one of the pupil surfaces 14, 15 of the optical elements 6. Pupil surface 15 is preferred for placement of the array 50.

Thereby, the two-dimensional arrays, consisting of individually controllable elements, are each arranged in an aperture plane of the imaging beam path and/or the illumination beam path. The control unit controls the individual elements of the array so that the diaphragm apertures and the filters can have arbitrary features. Arrays with different modes of technical functions can be used.

In a first variation of the preferred embodiment, the two-dimensional reflective arrays 50 are used for forming the diaphragms and/or filters. The reflection of these arrays can be regulated and they are used in the reflected light method. This includes, for instance, the Microscanner Mirror Arrays (1) of the MEMS type (micro electro mechanical system) or (2) of DMD type (digital mirror device), in which the mirrors with smaller dimensions can be tilted in two or more directions independent of each other. Microchopper arrays, in which a mirroring surface element can be displaced or tilted, also function similarly in reflecting manner.

FIG. 1 shows an arrangement of aperture diaphragms and/or filters, in which the position and/or the form can be changed, in the illumination beam path of a microscope for the inspection of the masks. In this way, an array of DMD type 5 that functions according the reflection principle is used as a two-dimensional array 50 consisting of individually controllable elements. In the illumination beam path 1, the light from the illumination source 2 is projected through the projection optical system 3 and a TIR prism 4 on the DMD array 5. The DMD array 5 is controlled by the control unit 22 for forming a previously determined diaphragm aperture and reflects the light in a form corresponding to the aperture of the diaphragm, through first diverse optical elements 6 for forming and guiding the light to the condenser optics 7, which focuses the light on the mask 8 to be inspected. The image of the mask 8 is formed in the observation beam path 9 by an objective lens 10, a tube lens 11 and second diverse optical elements 16 for forming and guiding light onto a CCD Matrix 12 serving the purpose of an image receiver and is evaluated by means of a computing unit (not shown here).

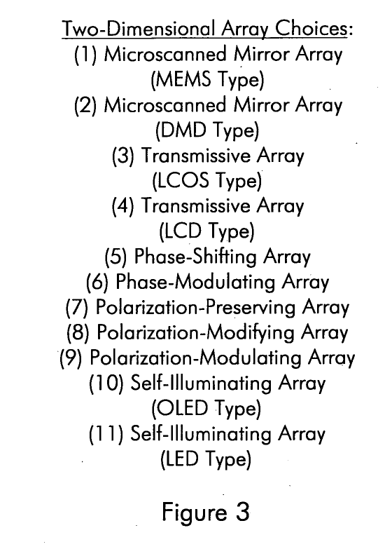

In a second variation of the preferred embodiment, two-dimensional transmissive arrays as listed in FIG. 3 are used for making the diaphragm apertures and/or filters, whereby their transparency to light can be regulated and which can be used in the transmitted light method. This type includes, for instance, the arrays (3) of the LCOS type (liquid crystal on silicon) or (4) of LCD type (liquid crystal display), which comprise individual liquid crystal cells, whose transparency for the polarized light can be regulated. Microshutter arrays, in which the individual surface elements can be tilted at 90° and which can thus transmit the light, also operate similarly in transmissive manner.

As listed in FIG. 3, in a third variation of the preferred embodiment, two-dimensional phase shifting (5) or phase modulating arrays (6) are used, which, on their part, can be operated in reflected light method. The micro-mechanical mirror arrays used in this case consist of pyramid or lowering elements that can be controlled individually. The individual, mirrored pyramid elements can be tilted for the modulation of the phase of the incident light. In contrast to that, the individual, also mirrored, lowering elements are lowered to a lesser or greater extent to achieve a phase shift in the incident light.

As listed in FIG. 3, use of two-dimensional polarization-preserving (7), polarization-modifying (8) or polarization-modulating arrays (9) represents a fourth variant of the preferred embodiment. In this way, the arrays used can be, for instance, of LCOS type (liquid crystal on silicon) or of LCD type (liquid crystal display), whereby the typically used polarizers and analyzers integrated into the display cell can be omitted. The array is thus equipped with only the locally controllable regions of the liquid crystal cells, which undergo a change in orientation due to the applied electric field thus leading to the corresponding polarization effect. This is exploited in the present case in order to generate targeted polarization distribution in an illuminating beam, which can be used with advantage in the inspection of the measured objects. The arrays can be operated with the reflection and/or the transmission method.

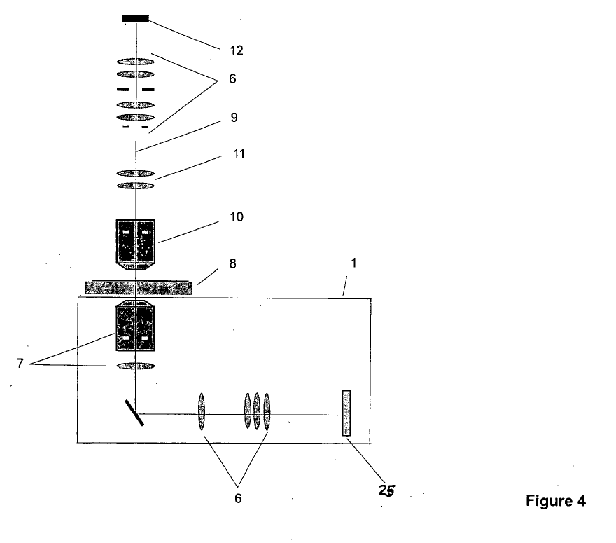

As listed in FIGS. 3 and 4, two-dimensional self-illuminating arrays represent another variation of an embodiment for forming diaphragm apertures and/or filters. The arrays (10) of the OLED type (organic light emitting diode) or (11) of LED type (light emitting diode) used in it consist of single, individually controllable elements, which, however, emit the light themselves, in contrast to the arrays described hereinbefore. This leads to further simplifications in the design due to the omission of the separate light source. In this embodiment, the illumination source 2, the projection optical system 3, and the TIR prism 4 of the reflective embodiments are eliminated.

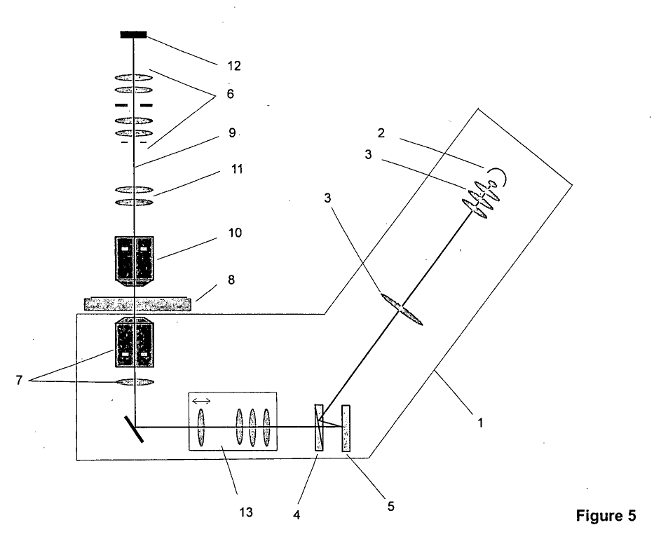

As shown in FIG. 5, in yet another preferred embodiment, in addition to the array present in the imaging and/or illuminating beam paths, zoom optics 13 are provided in order to enable a continuous variation in the size of the diaphragm aperture and/or of the filter represented by the array. The desired form of the diaphragm aperture is made as large as possible, that is, it is represented in the array by the lowest “raster” and is then imaged by means of the zoom optics 13 with the optical size as desired in the respective case. In contrast to the zoom systems customarily used in imaging systems, such as, for instance, of cameras, the zoom system described here is an aperture zoom system. Without the additional use of the zoom optics, the lateral resolution is limited by the finite pixel size.

With the help of the proposed technical solution, the geometry, the optical characteristics and/or the position of the aperture diaphragms and/or the filters can be controlled very quickly. These changes can also be made “online” during the process of measurement or adjustment in the sense of optical fine tuning. Furthermore, using these systems, the elaborate and time consuming preparation of the diaphragm apertures with geometric forms can be omitted.

The embodiments described here represent only an exemplary selection. Though not explicitly mentioned here, the arrangements according to the invention can also be used in other ways that may be obvious to the user. It is to be understood that the present invention is not limited to the illustrated embodiments described herein. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

1. An apparatus for use with an optical device, the apparatus comprising:
at least one of an imaging path and an illumination beam path;
at least one two-dimensional array made up of a plurality of individual controllable elements for forming aperture diaphragms and/or filters, wherein the array is arranged in at least one of the imaging path and the illumination beam path; and
a control unit for controlling the individual elements.

2. The apparatus according to claim 1, in which the at least two-dimensional array comprises individually controllable elements arranged in an aperture plane of the imaging path and/or illumination beam path.

3. The apparatus according to claim 1, in which two-dimensional reflective arrays are used to form the diaphragm apertures and/or filters.

4. The apparatus according to claim 1, in which two-dimensional transmissive arrays are used to form the diaphragm apertures and/or filters.

5. The apparatus according to claim 1, in which two-dimensional phase-shifting or phase-modulating arrays are used to form the diaphragm apertures and/or filters.

6. The apparatus according to claim 1, in which two-dimensional polarization-preserving, polarization-modifying or polarization-modulating arrays are used to form the diaphragm apertures and/or filters.

7. The apparatus according to claim 1, in which two-dimensional self-illuminating arrays are used to form the diaphragm apertures and/or filters so that a separate source of light can be omitted.

8. The apparatus according to claim 1, further comprising a zoom optics arranged in the imaging path and/or the illumination beam path for continuous variation of the size of the diaphragm aperture and/or filter constituting the two-dimensional array.

9. The apparatus according to claim 1 wherein the optical device is a microscope.

10. An apparatus for use with an optical device, the apparatus comprising:
an imaging path:
an illumination beam path; and
at least one two-dimensional array made up of a plurality of individual controllable elements for forming aperture diaphragms arranged at least one of the illumination beam path and the imaging path.

11. The apparatus of claim 10, further comprising:
a control unit for controlling the individual elements.

12. An apparatus for use with an optical device, the apparatus comprising:
an imaging path;
an illumination beam path; and
at least one two-dimensional array made up of a plurality of individual controllable elements for forming aperture filters arranged in at least one of the illumination beam path and the imaging path.

13. The apparatus of claim 12, further comprising:
a control unit for controlling the individual elements.
